(19) United States
(12) Patent Application Publication
(10) Pub. No.: US 2026/0095812 A1
(43) Pub. Date: Apr. 2, 2026

(54) SYSTEM AND METHOD FOR REQUESTING ALLOCATION OF RADIO FREQUENCY SPECTRUM AND TRANSMISSION OPERATIONAL PARAMETERS FOR AN INCIDENT LOCATION

(71) Applicant: MOTOROLA SOLUTIONS, INC., CHICAGO, IL (US)

(72) Inventors: BRADLEY MICHAEL HIBEN, GLEN ELLYN, IL (US); DAVID P. GURNEY, CARPENTERSVILLE, IL (US); GREGORY J. BUCHWALD, CRYSTAL LAKE, IL (US)

(21) Appl. No.: 18/903,672

(22) Filed: Oct. 1, 2024

(51) Int. Cl. H04W 28/20; G08G 1/14; H04L 5/00; H04W 28/02

(52) U.S. Cl. CPC H04W 28/20; G08G 1/14; H04L 5/0048; H04W 28/0215

(57) ABSTRACT

Techniques for requesting allocation of radio frequency spectrum and transmission operational parameters for an incident location are provided. An indication of an incident requiring a response is received at a dispatch center, the incident having an incident location. A first responding unit to respond to the incident is identified. Broadband transmission capabilities of the first responding unit are determined. A first allocation of Radio Frequency (RF) spectrum and transmission operational parameters covering at least a first portion of an area of the incident location based on the broadband transmission capabilities of the first responding unit are requested. An indication of the first allocation of RF spectrum, the transmission operational parameters, and the at least the first portion of the area of the incident location is sent to the first responding unit.

### BACKGROUND

In the field of Public Safety (e.g. Police, Fire, Emergency Medical Services, etc.), radio communications are considered mission critical services. The International Telecommunications Union refers to these systems as Public Protection and Disaster Relief (PPDR) communications systems. Typically, such communications occur via dedicated public safety communications networks (e.g. Project 25 (P25), TETRA, etc.) and are often referred to as Land Mobile Radio (LMR) networks. Over the years, these LMR networks and communications devices have evolved to be very high reliability and operate well, even when other communications networks (e.g. 4G LTE, 5G, etc.) may be not be capable of providing reliable service. In many cases, a public safety officer will have a LMR radio in a vehicle, which can be referred to as a mobile LMR radio. The public safety officer may also have a portable LMR radio (e.g. a walkie talkie, etc.) that the public safety officer carries on their person. In some implementations, the mobile LMR radio may be of higher power than the portable LMR radio. The portable LMR radio may use the mobile LMR radio as a gateway to connect to the broader LMR radio network. In addition, the LMR radios may also have the capability to operate on 4G or 5G communications networks.

In some cases, such as in a rural environment, there may be limited LMR, 4G or 5G radio network (e.g. cellular network) coverage at an incident scene. In order to overcome this problem, systems are available that allow for an alternative connection to the LMR network or cellular network via a different type of network backhaul. For example, the vehicle may be equipped with a satellite backhaul, such as a Low Earth Orbit (LEO) backhaul. The mobile LMR radio may use the satellite backhaul to relay communications back to the LMR network when no LMR network access is available, and to gain access to high speed data services via the cellular network. Because the LEO networks generally do not rely on ground infrastructure, it is generally available in areas where other types of networks are not available, such as during man-made or natural disasters, or in isolated geographic areas.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is an example of a vehicle equipped with an LEO backhaul and mobile broadband radio for communication with a portable radio according to the techniques described herein.

FIG. 2 is an example system that may implement the techniques described herein.

FIG. 3 is an example of a first responder being dispatched to an incident according to the techniques described herein.

FIGS. 4A and 4B are an example flow diagram of allocation of Radio Frequency Spectrum and transmission operational parameters according to the techniques described herein.

FIG. 5 is an example of a flow diagram where a second responding unit is dispatched to the incident according to the techniques described herein.

FIG. 6 is an example flow diagram of a mobile broadband radio receiving an allocation of Radio Frequency Spectrum and transmission operational parameters according to the techniques described herein.

FIG. 7 is an example of a device that may implement the dispatch center according to the techniques described herein.

FIG. 8 is an example of a device that may implement the mobile broadband device according to the techniques described herein.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

As described above, alternative communication techniques are available when there is limited LMR, 4G or 5G cellular network connectivity available. Although the alternative backhaul methods can alleviate the problem of limited connectivity to the LMR or cellular data networks, this still leaves the need for communication between the portable radio and the mobile radio (e.g. the radio in the vehicle). Typically, the portable radio and the mobile radio will communicate voice traffic using LMR, which uses licensed RF spectrum (e.g. dedicated spectrum for a single group of users that is not shared), although it may also be able to communicate via 4G or 5G radio networks to transfer broadband data (e.g., video, telemetry, or file sharing). These 4G or 5G networks may utilize licensed spectrum, unlicensed spectrum, or shared spectrum, and they may be localized in nature. In cases where regular LMR, 4G or 5G networks are limited or unavailable at an incident area, there may be no dedicated RF spectrum for communication between the portable radio and the mobile radio, for either voice or broadband data services.

The techniques described herein may overcome this problem through the use of shared spectrum systems, such as Citizens Broadband Radio Services (CBRS), to set up a localized broadband network at an incident scene. In a shared spectrum system, a user, such as a dispatch center operator or an automated dispatch system, may request allocation of RF spectrum and transmission operational parameters from a central authority. The central authority may grant the request for allocation of resources. The dispatch center operator may then send the allocation of RF spectrum and transmission operational parameters to a mobile broadband radio base station located in the vehicle. The mobile broadband radio may then use the allocated RF spectrum and transmission operational parameters to communicate with the portable radio(s) at an incident scene. It should be noted that a CBRS band base station is often termed a Citizens Broadband Radio Service Device (CBSD). If a broadband backhaul is available (e.g., commercial cellular or satellite service), the local portable radios can also communicate to the broader network (e.g., servers at the dispatch center, or websites on the Internet). Operation of the dispatch center and central authority will be described in further detail below.

One concern with requesting an allocation of RF spectrum and operation parameters from a central authority is that such allocation may take time. In order to alleviate this problem, the techniques described herein request the allocation in advance of a first responder arriving at an incident scene. The allocated RF spectrum and transmission operational parameters are sent to the first responder prior to arriving at the incident area. For example, the allocation information could be sent to the first responder as he is driving to the incident location. Because request for allocation of RF spectrum and transmission operational parameters occurs between the dispatch center, the central authority, and the broadband mobile radio in the vehicle directly, the first responder need not be aware or have to think about any of the complexities involved (e.g. frequency coordination, interoperability between multiple allocations, etc.). Note that the described techniques may be applied to other areas besides public safety work. For example, utility or enterprise workers may want to set up localized areas of broadband coverage when out in the field. For ease of understanding, the remainder of this description will be in terms of a public safety context. However, it should be understood the techniques described herein are not so limited.

Another concern is that when utilizing alternative backhaul resources, there may be constraints on accessing those alternative backhaul resources. For example, in the case of a LEO satellite backhaul, the vehicle will generally need a view of the open sky (e.g. not occluded by trees, tunnels, roadway overpasses, urban canyons, etc.). The techniques described herein take into account the type of backhaul in use and provide indications to the first responder indicating potential places to park the vehicle to minimize the amount of degradation of the alternative backhaul.

A method is provided. The method includes receiving, at a dispatch center, an indication of an incident requiring a response, the incident having an incident location. The method further includes identifying a first responding unit to respond to the incident. The method further includes determining broadband transmission capabilities of the first responding unit. The method further includes requesting a first allocation of Radio Frequency (RF) spectrum and transmission operational parameters covering at least a first portion of an area of the incident location based on the broadband transmission capabilities of the first responding unit. The method further includes sending to the first responding unit an indication of the first allocation of RF spectrum, the transmission operational parameters, and the at least the first portion of the area of the incident location.

In one aspect, requesting the first allocation further comprises contacting a spectrum server to obtain the first allocation of RF spectrum and transmission operational parameters. In one aspect, the method further comprises providing, to the first responding unit, a recommended parking location within the at least the first portion of the area of the incident location. In one aspect, the method further comprises requesting a second allocation of RF spectrum and transmission operational parameters covering at least a second portion of the area of the incident location based on the broadband capabilities of the first responding unit and requesting a second allocation of RF spectrum and transmission operational parameters covering at least a second portion of the area of the incident location based on the broadband capabilities of the first responding unit.

In one aspect, the method further comprises identifying a second responding unit to respond to the incident, determining broadband capabilities of the second responding unit, requesting a second allocation of RF spectrum and transmission operational parameters covering at least a second portion of the area of the incident location based on the broadband capabilities of the second responding unit, and sending to the second responding unit an indication of the second allocation of RF spectrum, the transmission operational parameters, and the at least the second portion of the area of the incident location.

In one aspect, the method further comprises determining a backhaul capability of the first responding unit, determining degradations within the at least the first portion of the area of the incident location that would interfere with the backhaul capability of the first responding unit, and sending to the first responding unit an indication of areas within the at least the first portion of the area of the incident location where the backhaul capability of the first responding unit may be impacted by the degradations. In one aspect requesting the first allocation of RF spectrum further comprises requesting RF spectrum from a Spectrum Access System (SAS) of a Citizens Broadband Radio Service (CBRS) operating in a 3.5 Gigahertz band that provides RF coverage at the location.

A system is provided. The system includes a processor and a memory coupled to the processor. The memory includes a set of instructions that when executed by the processor cause the processor to receive, at a dispatch center, an indication of an incident requiring a response, the incident having an incident location. The instructions further cause the processor to identify a first responding unit to respond to the incident. The instructions further cause the processor to determine broadband transmission capabilities of the first responding unit. The instructions further cause the processor to request a first allocation of Radio Frequency (RF) spectrum and transmission operational parameters covering at least a first portion of an area of the incident location based on the broadband transmission capabilities of the first responding unit. The instructions further cause the processor to send to the first responding unit an indication of the first allocation of RF spectrum, the transmission operational parameters, and the at least the first portion of the area of the incident location.

A non-transitory processor readable medium containing a set of instructions thereon is provided. The medium contains a set of instructions that when executed by a processor cause the processor to receive, at a dispatch center, an indication of an incident requiring a response, the incident having an incident location. The instructions on the medium further cause the processor to identify a first responding unit to respond to the incident. The instructions on the medium further cause the processor to determine broadband transmission capabilities of the first responding unit. The instructions on the medium further cause the processor to request a first allocation of Radio Frequency (RF) spectrum and transmission operational parameters covering at least a first portion of an area of the incident location based on the broadband transmission capabilities of the first responding unit. The instructions on the medium further cause the processor to send to the first responding unit an indication of the first allocation of RF spectrum, the transmission operational parameters, and the at least the first portion of the area of the incident location.

In one aspect, requesting the first allocation further comprises instructions that cause the processor to contact a spectrum server to obtain the first allocation of RF spectrum and transmission operational parameters. In one aspect, the instructions further cause the processor to provide, to the first responding unit, a recommended parking location within the at least the first portion of the area of the incident location. In one aspect, the instructions further cause the processor to request a second allocation of RF spectrum and transmission operational parameters covering at least a second portion of the area of the incident location based on the broadband capabilities of the first responding unit and send to the first responding unit an indication of the second allocation of RF spectrum, the transmission operational parameters, and the at least the second portion of the area of the incident location, wherein the first responding unit selects a parking location within the first portion of the area of the incident location or the second portion of the area of the incident location.

In one aspect, the instructions further cause the processor to identify a second responding unit to respond to the incident, determine broadband capabilities of the second responding unit, request a second allocation of RF spectrum and transmission operational parameters covering at least a second portion of the area of the incident location based on the broadband capabilities of the second responding unit, and send to the second responding unit an indication of the second allocation of RF spectrum, the transmission operational parameters, and the at least the second portion of the area of the incident location.

In one aspect, the instructions further cause the processor to determine a backhaul capability of the first responding unit, determine degradations within the at least the first portion of the area of the incident location that would interfere with the backhaul capability of the first responding unit, and send to the first responding unit an indication of areas within the at least the first portion of the area of the incident location where the backhaul capability of the first responding unit may be impacted by the degradations. In one aspect, requesting the first allocation of RF spectrum further comprises instructions that cause the processor to request RF spectrum from a Spectrum Access System (SAS) of a Citizens Broadband Radio Service (CBRS) operating in a 3.5 Gigahertz band that provides RF coverage at the location.

Further advantages and features consistent with this disclosure will be set forth in the following detailed description, with reference to the figures.

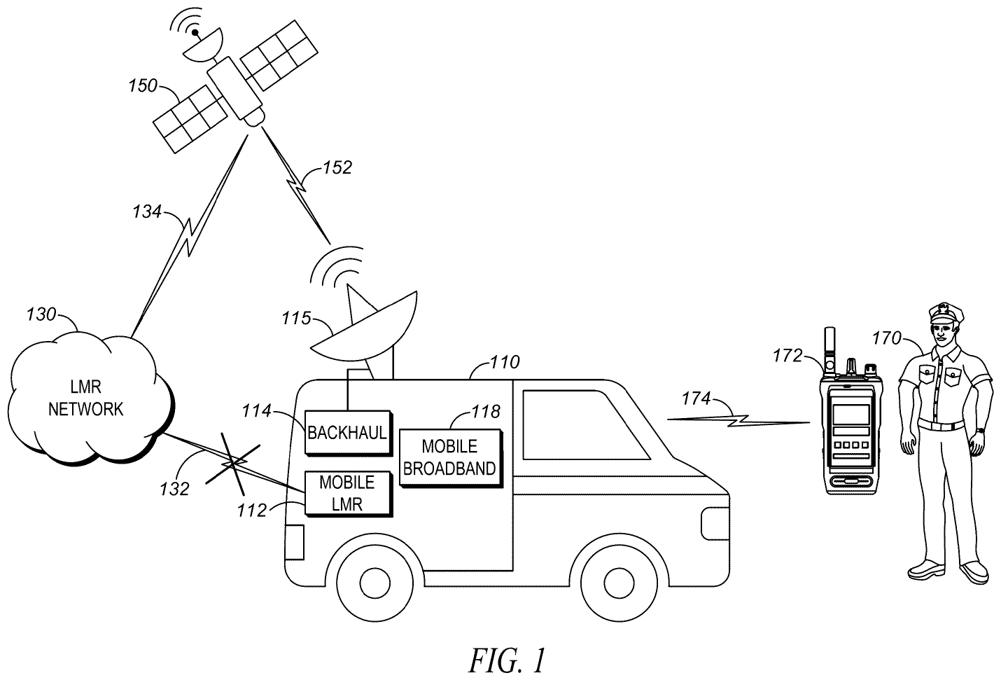

FIG. 1 is an example of a vehicle equipped with an LEO backhaul and mobile broadband radio for communication with a portable radio according to the techniques described herein. System 100 includes a vehicle 110, an LMR network 130, an alternative backhaul 150, and a first responder 170 with a portable radio 172.

The vehicle 110 is a vehicle that a first responder may use to travel to an incident location. An incident can be anything that requires assistance from a public safety agency. Some example incidents can include accidents, crimes, medical emergencies, fires, etc. The techniques describe herein may be utilized regardless of the type of incident. What should be understood is that an incident can be anything that requires a response from public safety personnel. The vehicle 110 is what the first responder uses to travel to the location of the incident.

The vehicle 110 may be equipped with a mobile LMR radio 112. The mobile LMR radio may be used to connect to the LMR network 130. As described above, LMR networks may be the mission critical radio networks that public safety personnel generally use. The LMR network may allow first responders to communicate with a dispatch center, other first responders, etc. In the examples to follow, it is assumed that at the incident location there is limited LMR network coverage. As such, there may be no connection 132 available between the mobile LMR 112 and the LMR Network 130 at the incident scene. What should be understood is that there may be LMR coverage as the vehicle is traveling to the incident location.

The vehicle 110 also includes a mobile broadband radio 118, which can function as a mobile broadband base station. The mobile broadband radio may be a radio that is usable with a shared spectrum system, such as a CBRS system, or with other bands that the mobile broadband radio utilizes. In a shared spectrum system, the mobile broadband radio receives an allocation of RF spectrum and transmission operational parameters from a central authority. A CBRS system generally operates in the 3.5 GHz band in the US, and may also operate on other bands world-wide. The central authority in a CBRS system is known as a Spectrum Access System (SAS). There may be multiple SAS providers available in the shared spectrum ecosystem, and they are typically authorized by the local spectrum Regulator (such as the FCC in the US). In other bands, the central authority may comprise an Automated Frequency Coordination (AFC) function, such as in the 6 GHz band in the US. Further spectrum access methods may also arise in allocations such as the 4.9 GHz public safety allocation.

In general, a request is made to the SAS for an RF spectrum allocation and transmission operational parameters (e.g. one or more requested operational frequencies, bandwidths, transmission power levels, antennae configuration, transmission location, etc.). The SAS determines if the request can be fulfilled. If so, the SAS allocates the requested RF spectrum and transmission operational parameters. Typically, the request is granted for an area within +/−50 meters of the location specified for use by the broadband radio transmitter. In other words, the mobile broadband radio is only authorized to use the RF spectrum in the specified area and only using the parameters specified by the SAS in the granted allocation. Regulations concerning the use of the U.S. CBRS band are documented in Part 96 of Title 47 of the Code of Federal Regulations, often abbreviated “47CFR96”. In addition, 47CFR96 stipulates that the broadband system's antenna height needs to be specified within +/−3 meters, which is readily achievable for a broadband transmission antenna mounted on a vehicle.

Although the description above uses CBRS as an example of a shared access broadband mechanism, it should be understood that the techniques described herein are not limited to CBRS. There are any number of alternative broadband shared access systems. For example, the 4.9 GHz band has been allocated for shared access public safety spectrum, on an area-licensed basis in the US. Alternatively, there are shared access systems in the 6 GHz band (as described above). The techniques described herein are not dependent on any particular implementation of shared, unlicensed, or licensed spectrum. What should be understood is that any shared spectrum, unlicensed or licensed system may be utilized with the techniques described herein.

The vehicle 110 may also be equipped with an alternative backhaul mechanism 114 that may be utilized in addition to, or when the LMR network 130 is not available to the mobile LMR radio 112. In the example shown, the alternative backhaul may be a LEO satellite backhaul. The alternative backhaul mechanism 114 may be coupled to an antenna 115 for communication 152 with a LEO satellite 150. The LEO satellite may be in communication 134 with the LMR network. Thus, when LMR connection 132 is limited or not available, the first responder, using either the portable LMR radio 172 or the mobile LMR radio 112 can communicate with the LMR network using the alternative backhaul as a relay.

Although LEO satellites 150 have been described as an alternative backhaul 114, it should be understood that this is only an example of one type of alternative backhaul. Other types may include cellular backhaul, microwave links, Wi-Fi, Bluetooth, wired backhaul, etc. What should be understood is that the alternative backhaul allows two way communication between the vehicle 110 and the LMR network 130 when there is no available connection between the mobile LMR radio 112 and the LMR network, and it also allows broadband data (e.g., video) to be communicated to first responders.

The system also includes a first responder 170 who is equipped with a portable broadband radio 172. The portable broadband radio is capable of communicating with the mobile broadband radio over communications link 174. The portable broadband radio may be integrated into the portable LMR radio 172, such that a single unit can communicate in both the LMR and cellular radio (e.g., 4G LTE, 5G) bands. The Motorola Solutions APX Next portable radio is an example of an LMR radio with integrated cellular capability. Note that both 4G and 5G cellular transmitters and systems can be accommodated in the CBRS band.

In operation, vehicle 110 may be designated as a first unit to respond to an incident at an incident location. It may be determined in advance, based on coverage maps, geo-spatial databases, etc. that the incident location has limited cellular and/or LMR coverage levels. As such, it will not be possible for either the mobile LMR 112 or the portable broadband radio 172 to communicate with the LMR network 130 once the vehicle has arrived at the incident location. In some cases, the first responders may wish to communicate using the localized shared spectrum broadband radio system, even if cellular or LMR radio services are available in the incident area. For example, first responders may wish to have the privacy and quality of service of a localized broadband connection, to quickly share data (e.g., videos, etc.) locally among responders. In another example, the available LMR system may not support the localized bandwidth needs of first responders (e.g., to send videos, or other data) needed to complete their tasks.

As will be described in more detail below, a dispatch center may be aware that there is limited cellular and/or LMR coverage at the incident location, or a more general need for localized broadband coverage in the incident area. The dispatch center may request RF spectrum and transmission operational parameters from a central authority. For example, in the case of a CBRS system, the central authority is the SAS provider (which is typically accessed via the internet). The dispatch center receives the allocation(s) of RF spectrum and transmission operational parameters and sends them to the vehicle 110. In some cases, as the vehicle is travelling to the incident location, it might still have a connection via the LMR network 130 or other data network (such as cellular or satellite). In such cases, the RF allocation information can be sent to the vehicle via the LMR connection 132, or any other alternative backhaul data connection 152 (e.g., cellular or satellite). Regardless of how received, the vehicle obtains the allocation information prior to arriving at the incident location. The received allocation information is then used by the mobile broadband radio 118 to establish communication with the portable radio 172 at the incident location.

As will be described in more detail below, upon arrival at the incident location, the vehicle 110 is provided with a portion (or several potential portions) of the incident area in which it is recommended to park the vehicle. This portion of the incident area may be based on factors that may cause degraded operation of the alternative backhaul 114. For example, for satellite backhaul, areas that have degraded views of the sky (e.g., tree cover, nearby buildings, or other obstructions) may be indicated to the first responder as less desirable areas to park the vehicle. Alternatively, for cellular backhaul, areas that have degraded cellular coverage levels (e.g., as determined by propagation modeling tools and cellular base station information) may be indicated to the first responder. Once parked, the first responder 170 may then leave the vehicle to attend to the incident. Note that the broadband system typically activates automatically once the vehicle is parked (within one of the several potential portions of the incident area). The first responder may then communicate (e.g., voice, video, data) via the localized broadband system that has been established, using their portable radio 172. The localized broadband system can be utilized to communicate with other users at the incident scene or the broader network (e.g., distant users, via the alternative backhaul network 114). For example, the first responder may key up the push-to-talk (PTT) microphone on her/his portable radio. The first responder may also communicate video and other data via the localized broadband link.

The communication from the portable radio 172 may then go over connection 174 to the mobile broadband radio 118. Because there may be limited or no LMR or cellular connection 132 available at the incident location, the communication may be routed to the alternative backhaul 114 if the communication needs to reach the broader network. The alternative backhaul may utilize the alternative backhaul resources (e.g. LEO satellite 150) to communicate with the LMR network 130 over communications link 134.

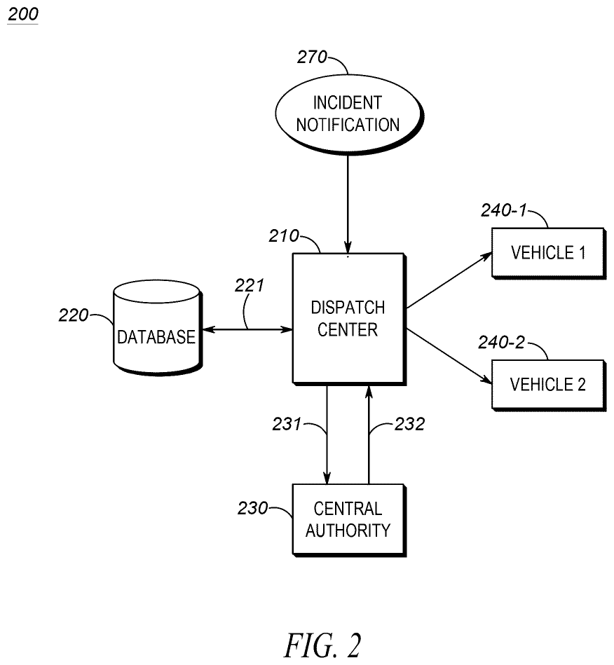

FIG. 2 is an example system that may implement the techniques described herein. System 200 may include a dispatch center 210, a database 220, a central authority 230, and vehicles 240-1,2.

Dispatch center 210 may be a public safety entity that receives indications of incidents and dispatches public safety first responders based on the incident type and available information about the incident. In many cases, the dispatch center may be integrated with a Public Safety Answering Point (PSAP) where emergency calls (e.g. 911 calls, etc.) reporting incidents are received. The dispatch center may also receive indications of incidents from other sources (e.g. automated alarm systems, etc.). What should be understood is that the dispatch system receives indications of incidents and dispatches first responders accordingly.

Coupled to the dispatch center 210 may be database 220. The database may include information such as the availability of LMR, cellular and satellite backhaul coverage over a given geographic area. The database may also include geospatial information, such as aerial/satellite photography of the area. As will be explained in further detail below, this information may be utilized to determine if the incident has occurred in an area with limited LMR or cellular coverage and to provide guidance in selecting a parking spot that will reduce the likelihood of degradation of the alternative backhaul mechanism.

System 200 may also include a central authority 230. The central authority is the entity that receives requests for allocation of shared RF spectrum and transmission operational parameters for the allocated RF spectrum. In the case of a CBRS system, the central authority is known as a SAS. Other shared spectrum systems may utilize different central authorities (e.g. Automated Frequency Controller, etc.). What should be understood is that regardless of the particular shared spectrum system in use, the central authority represents the entity from which RF spectrum and transmission operational parameters are requested and whose responsibility it is to arbitrate amongst requests and provide allocations of RF spectrum and transmission operational parameters as appropriate.

System 200 also includes vehicles 240. Although only two vehicles, 240-1, 240-2 are shown, it should be understood that this is for ease of description only and not by way of limitation. An actual implementation could have any number of vehicles. Vehicles 240 are generally describe with respect to FIG. 1, and the description will not be repeated here.

In operation, an incident notification 270 may be received at the dispatch center 210. The incident could come from any source, such as a caller to 911, and incident report submitted via social media, an incident submitted via text message, etc. In some cases, incidents may be sent to the dispatch center from automated systems (e.g. alarm systems, etc.). What should be understood is that the source of the incident notification is unimportant. Furthermore, the type of incident is also unimportant, so long as it requires a response from at least one public safety responder vehicle. The incident could be a fire, an accident, a medical emergency, a crime, etc. Any type of incident that requires a response to a defined location (e.g. the incident area, etc.) is suitable for use with the techniques described herein. Similarly, for enterprise or utility customers, an incident may include areas where workers need to be dispatched to perform maintenance or repair (e.g., in order to service a work ticket).

Upon receipt of the incident notification 270, the dispatch center 210 may query 221 database 220 for information related to the incident location. As mentioned above, the database may include LMR, broadband cellular and satellite service coverage maps which may be used to determine if particular forms of connectivity are available at the incident location. Furthermore, the database may include information related to the incident location that could affect the performance of the alternative backhaul mechanism (such as LMR or cellular signal strength levels, interference levels, satellite signal quality metrics, system loading levels/available capacity, and the like).

Based on the information from the database 220, the dispatch center 210 may determine that LMR or cellular connectivity is limited at the incident location and that it may be desirable to request shared spectrum at the incident location to enable communication between the mobile broadband radio in the vehicle 240 and the portable radio used by the first responder. The dispatch center may determine, based on information from the database, the broadband capabilities of a vehicle 240-1 chosen to respond to the incident location. For example, the database may indicate that vehicle 240-1 is equipped with a CBRS broadband radio base station, i.e., a CBSD. In some cases, multiple vehicles may need to respond, each having similar or different broadband radio capabilities (e.g., a larger command van may support a higher power broadband transmitter, compared to a smaller vehicle). The dispatch center is aware of the broadband capabilities of each vehicle dispatched to the incident (e.g., through vehicle information contained in database 220, or a similar database).

For each vehicle, the dispatch center 210 may send at least one request 231 to the central authority 230 to request at least one RF spectrum allocation and transmission operational parameters for the incident location. There may be separate requests for each vehicle that is being dispatched to the incident location. The allocation requests are sent to the central authority in charge of allocation for the particular band. For example, in the case of CBRS, the central authority will be the SAS. Other broadband technologies may use different nomenclature, but the functionality is the similar. In other cases, central authority may contain spectrum use licenses for different regions, such as the case in the 4.9 GHz band in the U.S.

For a CBRS band spectrum allocation request, the request may include an identifier of the requestor (e.g., vehicle base station serial number), a desired frequency range, a maximum transmit or effective isotropic radiated power (EIRP) level, antenna parameters (e.g., antenna height, gain, pattern and pointing angles if directional), transmitter location (within +/−50 meters horizontally and +/−3 m vertically) and any other transmission operational parameters needed by the SAS to evaluate the grant request. The central authority 230 may then evaluate the request to determine if it can be fulfilled (e.g. frequency not currently in use by a higher priority users, requested power will not cause interference to incumbents, etc.). It should be understood that the particular contents of the grant request are dependent of the specific type of shared spectrum system. The techniques described herein are not limited to any particular type of shared spectrum system.

After evaluating the request, the central authority 230 may determine that the requested RF spectrum can be allocated for a (+/−50 m) portion of the incident area. The central authority may respond 232 to the dispatch center with the RF spectrum and transmission operational parameters that have been granted. Such parameters can include transmit permissions, EIRP level, channel frequency, bandwidth, etc. It should be understood that the granted RF spectrum and transmission operational parameters need not be the same as what was requested. The mobile broadband radio base station is limited to only use the RF spectrum and transmission operational parameters that were granted. Once again, it should be understood that the specific transmission operational parameters are dependent of the particular type of shared spectrum system. The techniques described herein are not limited to any particular type of shared spectrum system.

Once the grant response 232 is received, the allocated RF spectrum and transmission operational parameters are sent to the vehicles 240. As explained above, as the vehicle is traveling toward the incident location, the vehicle may still have LMR, cellular or satellite connectivity. In such cases the information may be sent to the vehicle via the appropriate available network. It should be noted that multiple grant requests 231 for a particular vehicle (e.g., 240-1) may be made to the central authority 230 by the dispatch center 210, each corresponding to a different (+/−50 m) portion of the incident area, and only the spectrum grant (and transmission operational parameters) of the grant corresponding to the vehicle parking area be utilized. In this manner, the first responder is given freedom to locate their vehicle at one of several potential parking locations at an incident scene.

In the case where multiple vehicles 240 are responding to the incident, each vehicle may also receive different grants of RF spectrum and transmission operational parameters. If all vehicle are utilizing the same shared spectrum system, the information sent to each vehicle may include information related to other grants. This information may be used to allow the responding vehicle to set up a local system at the incident location. For example, information about the neighbors to a particular grant may be received that will allow the portable radios from each vehicle 240 to seamlessly handover to the mobile broadband radio of other vehicles. In 4G LTE based localized mobile broadband systems, information about neighboring localized mobile broadband cells (e.g., dynamic frequencies, cell identifiers, IP addresses, etc.) can automatically be populated (statically) in the Neighbor Relations Tables of all base stations at an incident scene, facilitating seamless (e.g., using LTE's X2 interface) handovers among all base stations.

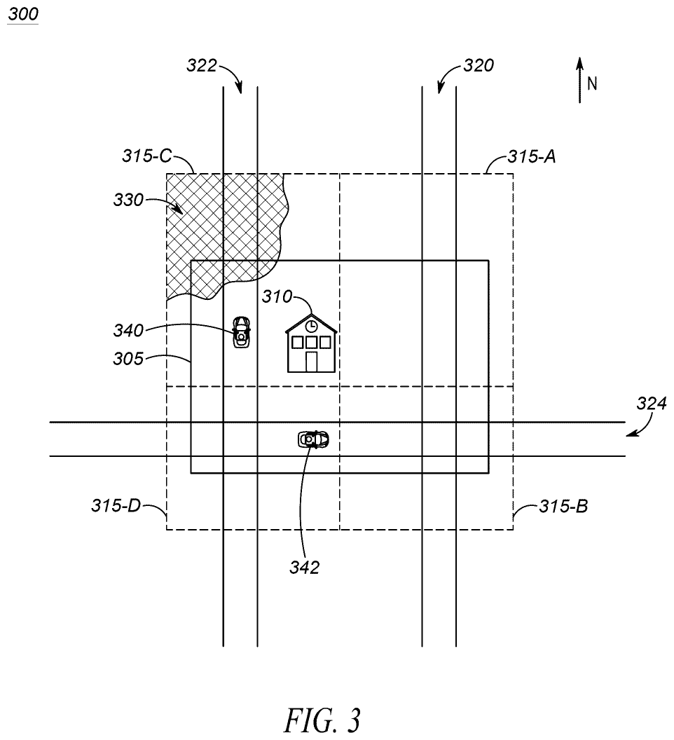

FIG. 3 is an example of a first responder being dispatched to an incident according to the techniques described herein. Area 300 depicts an incident area location 305, where an incident has occurred/is occurring. For example, the incident may be a suspected prowler is on the grounds of a house 310. For purposes of this example description, assume it has already been determined that there is limited or even no LMR and/or cellular connectivity at the incident location.

Because there may be limited LMR or cellular connectivity at the incident location, or the local first responders wish to utilize a localized broadband network, the dispatch center requests shared spectrum to provide coverage at the incident location. As explained above, shared spectrum systems typically provide grants of RF spectrum and transmission operational parameters for a small area. For example, in CBRS systems, the grant generally requires the CBSD to be in an area approximately +/−50 meters from the grant location. For ease of description, the grant location area is going to be described in terms of squares, however it should be understood that any polygonal shape can be made up of the squares. What should also be understood is that the allocation of RF spectrum and transmission operational parameters is valid for a finite area. If the larger incident area is made up of several smaller (+/−50 m) squares, a spectrum grant is obtained for each of the smaller squares, which represents a potential operating (vehicle parking) location for the localized broadband system. Generally, the coverage area of a CBSD with antennas mounted on the roof of a car is expected to be substantially larger than a square 100×100 meters but regulations require the CBSD be within +/−50 meters of its granted location and the primary reason for obtaining grants for multiple areas is to give the responder flexibility in parking her/his car.

In the example presented, it is assumed that the incident area cannot be covered with a single shared spectrum grant. In this example, the dispatch center may have requested four grants of RF spectrum and transmission operational parameters for the incident location 305. Assuming that requests were granted, there may be four coverage areas 315-A-D. The information about the incident location and the respective grants of shared spectrum can be shared with vehicles responding to the incident. For example, the information can be shared in the form of a map. As will be explained in further detail below, color coding on the map may be used to provide guidance to the first responder as to where to park.

There are three roads shown around the incident location 305. Road 320 and 322 are North-South roads running along the east and west side of the incident location. There is also a road 324 running east west along the south end of the incident location. As should be clear, depending on where the first responder parks, that will determine the coverage area for communication between their portable radio and the mobile broadband radio in the vehicle. This coverage area may be precomputed using propagation models (including terrain and clutter databases), and knowledge of the transmission operational parameters (e.g., antenna gains, heights, transmission power levels, broadband base station locations, etc.), and provided to the first responders (e.g., displayed on a local computer screen). Estimated signal levels and throughput levels (for both downlink and uplink communications) can also be generated for the coverage area for each broadband base station at the scene, and made available to first responders. Note that the vehicular broadband base station will automatically activate once the vehicle is parked, typically based on the actual GPS coordinates of the vehicle, which is in turn utilized to obtain the corresponding spectrum grant and transmission operational parameters (within the +/−50 m square described above) for the broadband base station transmitter. Depending on which square the first responder vehicle is parked in, and the local terrain and clutter, the corresponding localized broadband base station may be able to cover the entire incident area, or only a portion of the overall incident area.

For example, in a high clutter environment (e.g., with many surrounding buildings and trees), if the first responder parks his vehicle in area 315-A, as long as they stay in that area, they will have the ability to communicate at high data rates to the car via the broadband link with their portable radio. However, if they leave area 315-A, they may no longer be able to communicate with their mobile broadband radio at high data rates, unless additional vehicles also respond. Such a situation will be described in further detail below. Other first responder vehicles may also arrive at the incident scene to provide additional capacity (i.e., available data throughput) to first responders in the incident area (e.g., to enable more live video streams to be communicated).

As should be clear from the general discussion above, the location where a first responder parks can have an impact on the broadband communications capabilities (e.g., coverage area and throughput). For example, if the main activity of the incident is a suspected prowler around house 310, then the first responder would likely want to park in area 315-C, on road 322 as that is the area that covers the house. However, if the incident is a fire at the house, the first responder may wish to park in an area further away from the house such as on road 320 or 324. What should be understood is that the first responder is provided with information about coverage by the shared spectrum system, and based on that information may choose the best place to park. Alternatively, they may park in the best place to complete their mission. As mentioned above, the local broadband base station is typically automatically activated once the vehicle stops on scene (with the corresponding transmission operational parameters), freeing the first responder to focus on their core mission.

The information provided to the first responder (e.g., in the vehicle) may also include information about portions of the incident area that include features that degrade the alternative backhaul capabilities. For example, in the case of LEO satellites being used as alternative backhaul, the presence of trees or other overhead obstructions may cause degraded communications because of lack of line of sight to the satellites. The information provided may include an indication of an area 330 that is covered in trees, thus having the potential to degrade LEO satellite backhaul. As above, signal level or throughput estimates may be provided for the various areas around an incident scene. The first responder may receive this information and determine it would be better to park in an area outside of area 330.

In some implementations, when a first responder arrives at the incident location and parks the vehicle, and indication is provided on the display 300 indicating that the area is currently occupied. For example, each area 315-A-D may initially be outlined in green, indicating no first responder is in any of those areas. When the first first responder arrives and chooses to park at location 340, the boundary of area 315-C may turn red, indicating that area is currently occupied. When the next first responder arrives, they will see that area 315-C is already occupied, and can select a different area.

The ability to determine which areas are already occupied such that multiple responders do not park in the same coverage area can be beneficial. As explained above, the information needed to allow the vehicles to set up a coverage area that provides the ability to handoff between mobile broadband radios can be very useful. For example, if the first first responder parks at location 340, and then the responder moves into area 315-D, they would have left their coverage area and would no longer be able to communicate with their own mobile broadband radio. However, if a second first responder 342 arrives, and parks in area 315-D, then the first first responder's portable radio would have the ability to handover to the second first responders mobile broadband radio.

As mentioned above, additional first responder vehicles may arrive on scene to provide additional localized broadband system capacity or coverage. In general, it is assumed that the dispatch center will provide individual and unique spectrum grants to each vehicle arriving on scene, such that if two first responder vehicles are parked close to each other (say, in area 315-A), they will be assigned different operational frequencies to avoid interference amongst the localized broadband base stations. Furthermore, if the incident area is large enough (e.g., a large search area, a large enterprise campus or factory), the dispatch center may obtain spectrum grants on the same operational frequency (since interference among the responding vehicles will be less of a concern due to propagation losses among the two locations). The dispatch center may obtain multiple spectrum grants for each sub-area (e.g., 315-A through 315-D) to better accommodate these types of arrangements, and the potential interference between different localized broadband base station locations may be pre-computed to automatically assign responding units the best operational frequencies and transmission operational parameters as they arrive on scene (and park in a particular sub-area.

The example presented with respect to FIG. 3 is only one example of how the RF spectrum and operational parameter information can be conveyed to the first responders. What should be understood is that the various areas of shared spectrum coverage areas, including which areas are currently occupied, may be presented to the first responder and/or dispatch center operator. The information also includes factor that may affect the capabilities of the alternative backhaul. Based on this information, the first responder may decide where to park to achieve the best coverage. In some implementations, the dispatch center may additionally provide recommendations or mandates as to where the first responder should park.

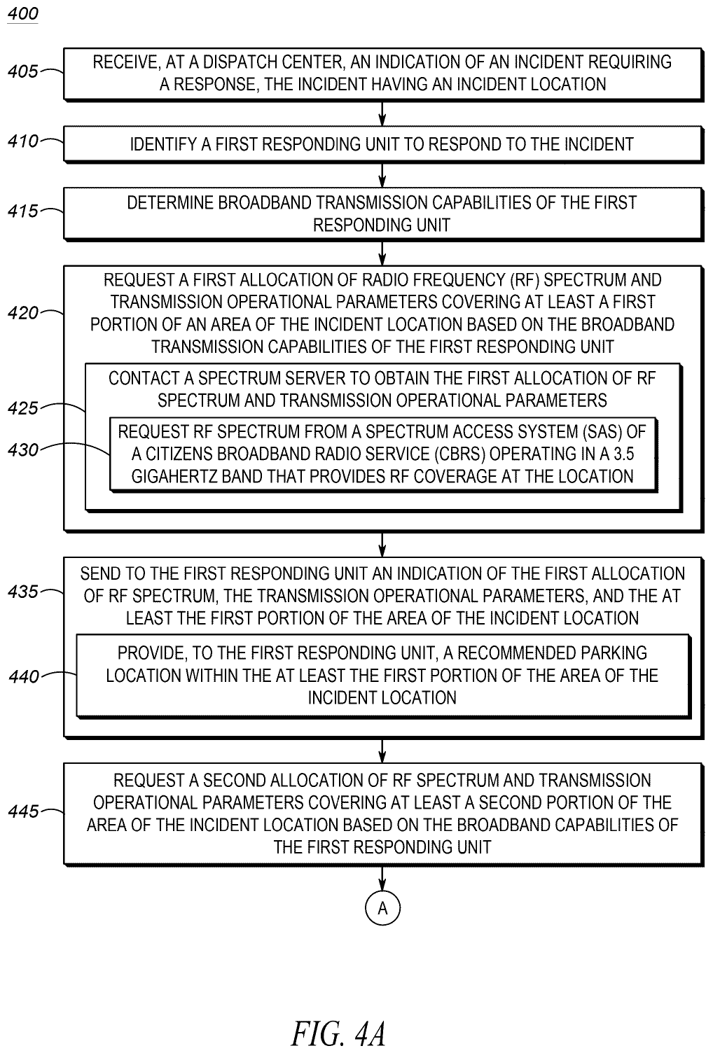

FIGS. 4A and 4B are an example flow diagram 400 of allocation of Radio Frequency Spectrum and transmission operational parameters according to the techniques described herein. In block 405, an indication of an incident requiring a response is received at a dispatch center. The incident having an incident location. As explained above, a dispatch center may receive a notification of an incident that requires a response from a first responder. The source of the incident is somewhat unimportant. What should be understood is that the indication that an incident has occurred is received along with an indication of the location of the received incident.

In block 410, a first responding unit to respond to the incident is identified. The first responding unit may be identified based on the type of incident. For example, for a criminal type incident (e.g. robbery, assault, etc.) it is likely that a police officer unit will be needed to respond to the incident. Likewise, for a fire type incident, a response from the fire department would be needed. Identifying units to respond to a given incident type is well known in the field of public safety dispatch. Similarly, the estimated size of the overall incident area may be determined by the dispatch center, based on knowledge of the incident type (e.g., a small house fire vs. a large oil refinery fire), and dispatch center software may utilize that information to obtain any number of smaller (+/−50 m sub-area) spectrum grants for the overall incident area. Each sub-area may also have multiple grants on different operational frequencies, as described above.

In block 415, broadband transmission capabilities of the first responding unit are determined. The techniques described herein are utilized when LMR or cellular coverage may be limited or not available at an incident location, or localized broadband communications are desired at an incident scene. In this case, resources from a shared spectrum broadband system, such as a CBRS system, are utilized to provide communication between a mobile broadband radio base station and a portable radio. Determining the broadband transmission capabilities of the first responding unit is needed in order to request spectrum and transmission operational parameters from a central authority (e.g. SAS, etc.) that are compatible with the capabilities of the first responding unit.

In block 420, a first allocation of Radio Frequency (RF) spectrum and transmission operational parameters covering at least a first portion of an area of the incident location based on the broadband transmission capabilities of the first responding unit is requested. As described above, generally shared spectrum systems provide grants of RF spectrum and for a defined area. For example, within +/−50 meters from the location of the grant. In some cases, the area that is able to be granted is smaller than the area of the incident. For example, an incident may be a hiker lost in a 5000 square meter forest. If the area of granted resources is 50 square meters, it should be clear that the grant will only cover a portion of the incident area. As will be explained in further detail below, multiple requests for allocation of RF spectrum and transmission operational parameters when a single request is not sufficient to cover the incident area.

In block 425, a spectrum server is contacted to obtain the first allocation of RF spectrum and transmission operational parameters. In shared spectrum systems, a central authority is contacted with requests for RF spectrum and transmission operational parameters. This central authority may generically be referred to as a spectrum server. The central authority receives the request, examines the parameters of the request, and determines if the request, or a modified version of the request, should be granted. In some cases, the initial request may be modified based on the currently available resources of the shared spectrum system (e.g. full requested frequency range unavailable, transmit power requested greater than what can be granted, etc.).

In block 430, requesting the first allocation of RF spectrum and transmission operational parameters further comprises requesting RF spectrum from a Spectrum Access System (SAS) of a Citizens Broadband Radio Service (CBRS) operating in a 3.55-3.70 Gigahertz band that provides broadband RF coverage at the location. As explained above, a CBRS system is one example of a shared spectrum system that uses a central authority known as a Spectrum Access System. Requests for RF spectrum allocation are sent to the SAS when the shared spectrum system is a CBRS system.

In block 435, an indication of the first allocation of RF spectrum, the transmission operational parameters, and the at least the first portion of the area of the incident location is sent to the first responding unit. As described above, in some implementations, the indication is sent to the first responding unit in the form of a map indicating where shared RF spectrum coverage is available to aid in the selection of a parking location when the first responder arrives at the incident location.

In block 440, the first responding unit may be provided a recommended parking location within the at least the first portion of the area of the incident location. In other words, the first responding unit may be provided a recommendation of where to park when arriving at the incident location to best utilize the granted first allocation of RF spectrum and transmission operational parameters. The recommendation may be based on incident type, type of shared spectrum in use, number of responding units, or any number of other factors.

In block 445, a second allocation of RF spectrum and transmission operational parameters covering at least a second portion of the area of the incident location is requested based on the broadband capabilities of the first responding unit. As explained above, given the nature of shared RF spectrum systems, the area of grants might be relatively small as compared with the area of an incident. In such cases, multiple grants may be requested from the central authority in order to provide coverage over the entire incident area.

In block 450, an indication of the second allocation of RF spectrum, the transmission operational parameters, and the at least the second portion of the area of the incident location are sent to the first responding unit. The first responding unit selects a parking location within the first portion of the area of the incident location or the second portion of the area of the incident location. As described above, the incident area may be too large to be covered by a single grant request. As such, multiple grant requests may be made. The first responding unit may receive this information through an interface such as a map interface. The first responding unit may then select a parking location within the grant areas based on criteria such as the incident type.

In block 455, a backhaul capability of the first responding unit is determined. The techniques described herein are generally used when connectivity to an LMR or cellular network is limited or unavailable, or additional localized broadband data capabilities are desired at an incident scene. In such cases, an alternative backhaul capability may be used to communicate with the broader LMR or cellular network. It is necessary to determine which alternative backhaul capability the first responding unit is using in order to provide more detailed coverage information.

In block 460, degradations within the at least the first portion of the area of the incident location that would interfere with the backhaul capability of the first responding unit are determined. The types of degradations are dependent on the type of backhaul being used. For example, backhaul using LEO satellites are subject to degradation when there is not a clear line of sight to the sky. For example, tree cover or buildings can interfere with LEO satellite communications. Different types of backhaul may have different types of degradation. For example, an RF backhaul based on commercial cellular or Wi-Fi may also be degraded due to buildings or foliage (and these effects can be pre-determined based on coverage/propagation modeling tools, as described above). For example, an incident area located far away from a commercial cellular base station tower may have poor commercial cellular data coverage. What should be understood is that any factors that may degrade the performance of the backhaul are determined.

In block 465, an indication of areas within the at least the first portion of the area of the incident location where the backhaul capability of the first responding unit may be impacted by the degradations are sent to the first responding unit. In other words, the first responding unit is made aware of areas within the granted area where there may be issues with backhaul capabilities are pointed out to the first responding unit in order to allow the first responding unit to park in an area where backhaul will not be degraded. For example, in the case where backhaul is LEO satellite and indication of where there is tree cover or large buildings may be provided. For example, the area where there is tree coverage may be displayed on a map that also includes the shared spectrum coverage areas. In other cases, where the backhaul is provided by commercial broadband cellular service providers, signal level or throughput degradations due to terrain, buildings or foliage may be displayed on the map. The first responding unit can choose to park in a location that is not occluded by trees or buildings, thus preventing degradation of the backhaul capabilities.

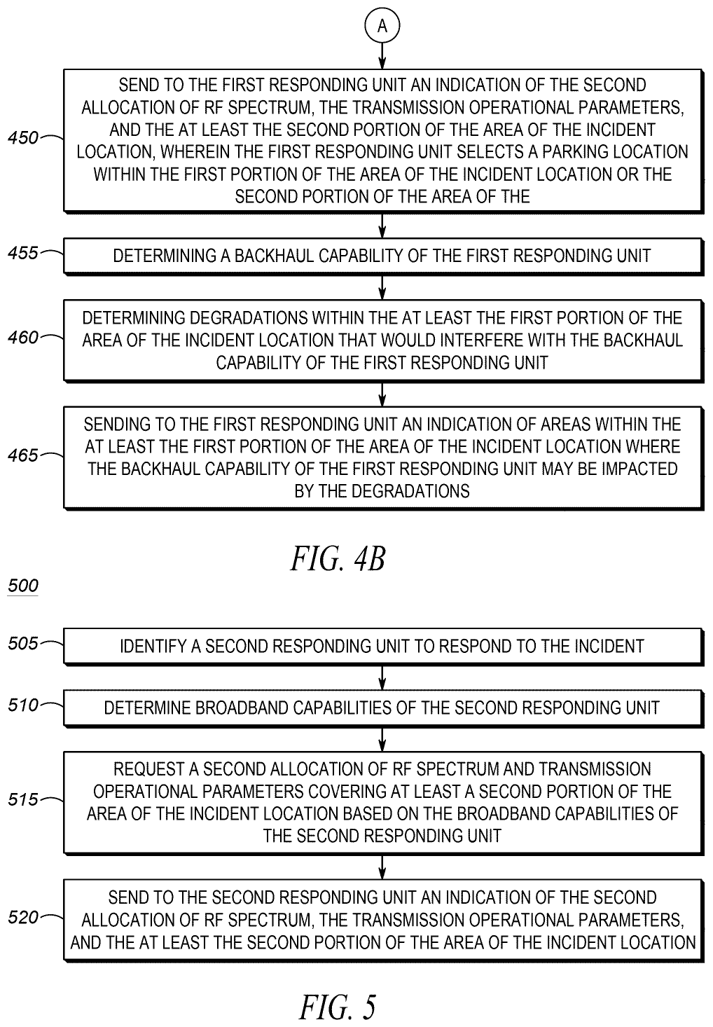

FIG. 5 is an example of a flow diagram 500 where a second responding unit is dispatched to the incident according to the techniques described herein. In block 505, a second responding unit to respond to the incident is identified. In some cases, depending on the incident type, more than one unit may be required to respond to an incident. For example, in the case on an incident involving weapons, law enforcement may require multiple units to respond for safety. The particular reason why multiple responding units are needed is relatively unimportant.

In block 510, broadband capabilities of the second responding unit are determined. Just as above with the first responding unit, the type of shared spectrum request is based on the ability of the responding unit to utilize the grant. In order to request the proper type of RF spectrum and transmission operational parameters, the capabilities of the second responding unit need to be determined.

In block 515, a second allocation of RF spectrum and transmission operational parameters covering at least a second portion of the area of the incident location based on the broadband capabilities of the second responding unit is requested. In other words, there may be two units responding to the incident. There is a request for spectrum grant for the second responding unit that may cover an area that is different than the first responding unit. This may be beneficial, as it may allow more of the actual incident area to be covered using the shared RF spectrum and transmission operational parameters. Alternatively, the spectrum grants may cover an area that overlaps (partially or completely) with the first responding unit. Frequency coordination may also be done to avoid RF interference among the responding units.

In block 520, an indication of the second allocation of RF spectrum, the transmission operational parameters, and the at least the second portion of the area of the incident location is sent to the second responding unit. Just as above with respect to the first responding unit, information about the grant is sent to the second responding unit. For example, the information may be sent using a map interface. The second responding unit may then use this information to determine where to park when arriving at the incident location. In some cases, the location is chosen to maximize the amount of the incident location area covered by the first and second responding units.

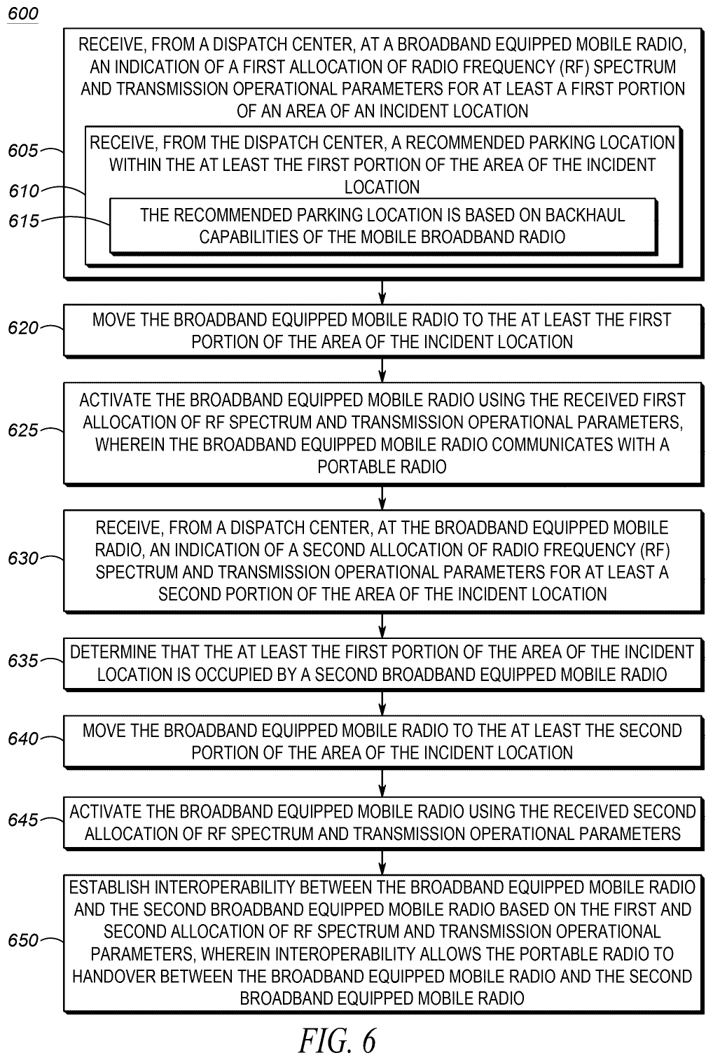

FIG. 6 is an example flow diagram 600 of a mobile broadband radio receiving an allocation of Radio Frequency Spectrum and transmission operational parameters according to the techniques described herein. In block 605, an indication of a first allocation of Radio Frequency (RF) spectrum and transmission operational parameters for at least a first portion of an area of an incident location is received from a dispatch center at a broadband equipped mobile radio. As explained above, when LMR or cellular connectivity is limited at an incident location, shared spectrum resources for use by a broadband equipped mobile radio base station (i.e. local base station) are requested. These resources are then conveyed to the mobile broadband radio. In some implementations, this information is conveyed to the vehicle including the mobile broadband radio via a map based interface.

In block 610, a recommended parking location within the at least the first portion of the area of the incident location is received from the dispatch center. In some implementations, the dispatch center may recommend, or even mandate, where the mobile broadband radio (i.e. the vehicle including the mobile broadband radio base station) should be parked within an incident location. This location may be determined based on factors such as where a greatest amount of coverage can be provided, based on multiple units responding, or any number of other factors.

In block 615, the recommended parking location is based on backhaul capabilities of the mobile broadband radio being degraded. As explained above, depending on the type of backhaul, different types of degradation can occur. In the techniques described herein, the dispatch center may recommend a parking location such that degradation of the backhaul capabilities is minimized. For example, if the backhaul is through LEO satellite, the dispatch center may recommend parking in locations with clear line of sight to the sky (e.g. no tree cover). In other examples, for commercial cellular backhauls, it may recommend parking locations closest to an unobstructed view of a commercial cellular base station. In both cases, the goal is to maximize signal and throughput levels for backhaul link.

In block 620, the broadband equipped mobile radio is moved to the at least the first portion of the area of the incident location. In general, this means that the vehicle including the broadband equipped mobile radio is moved to a location within the first portion of the area of the incident location. In other words, the vehicle is parked in a location within the incident area that has had shared spectrum requested and granted.

In block 625, the local base station is activated using the received first allocation of RF spectrum and transmission operational parameters, wherein the broadband equipped mobile radio communicates with a portable radio. In other words, the local base station is configured to utilize the grant from the shared spectrum system. The grant is utilized to communicate with a portable radio in the possession of the first responder responding to the incident. Communications from the portable radio may be relayed via the broadband equipped mobile radio to the alternate backhaul to the LMR network or a cellular data network (e.g., a public data network such as the internet, or a private data network).

In block 630, an indication of a second allocation of Radio Frequency (RF) spectrum and transmission operational parameters for at least a second portion of the area of the incident location is received from a dispatch center, at the broadband equipped mobile radio. In some cases, a single grant may not be sufficient to cover the entirety of an incident area. In such cases, multiple requests for shared spectrum may be made to ensure coverage of the incident area.

In block 635, it is determined that the at least the first portion of the area of the incident location is occupied by a second broadband equipped mobile radio. In other words, it is determined if a different responding unit has already occupied the first portion of the incident area. As explained above, in some cases, this may be determined via a map interface. When a portion of the incident area is unoccupied, the portion may be indicated in green. When a unit has occupied that portion, it may be displayed as red. This is to help prevent two responding units from attempting to occupy that same portion of the incident area, which in turn prevents different units from attempting to use the same RF spectrum grant. In other cases, multiple spectrum grants for different operating frequencies or channels may be obtained for the two responding units.

In block 640, the local base station is moved to the at least the second portion of the area of the incident location. In other words, the vehicle including the local base station is moved to a portion of the incident area that has not already been occupied by another responding unit.

In block 645, the local base station is activated using the received second allocation of RF spectrum and transmission operational parameters. Just as above, the local base station is activated using the grant that was provided for the second allocation (e.g. the second portion of the incident location area).

In block 650, interoperability is established between the local base station and the second local base station based on the first and second allocation of RF spectrum and transmission operational parameters. The interoperability allows the portable radio to seamlessly handover between the local base station and the second local base station. In other words, the portable radio is able to handover between the local base stations. For example, if a portable radio associated with one vehicle located in the first portion of the incident area should move to a second portion of the incident area that is covered by a different vehicle, the portable radio would be able to seamlessly handover from the first broadband equipped mobile radio to the second broadband equipped mobile radio.

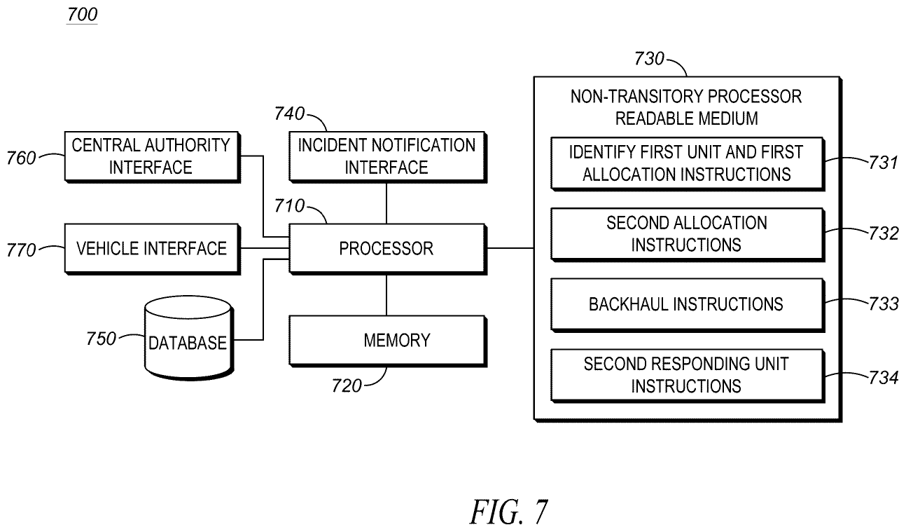

FIG. 7 is an example of a device 700 that may implement the dispatch center according to the techniques described herein. It should be understood that FIG. 7 represents one example implementation of a computing device that utilizes the techniques described herein. Although only a single processor is shown, it would be readily understood that a person of skill in the art would recognize that distributed implementations are also possible. For example, the various pieces of functionality described above (e.g. identifying first and second allocations, backhaul instructions, etc.) could be implemented on multiple devices that are communicatively coupled. FIG. 7 is not intended to imply that all the functionality described above must be implemented on a single device.

Device 700 may include processor 710, memory 720, non-transitory processor readable medium 730, incident notification interface 740, database 750, central authority interface 760, and vehicle interface 770.

Processor 710 may be coupled to memory 720. Memory 720 may store a set of instructions that when executed by processor 710 cause processor 710 to implement the techniques described herein. Processor 710 may cause memory 720 to load a set of processor executable instructions from non-transitory processor readable medium 730. Non-transitory processor readable medium 730 may contain a set of instructions thereon that when executed by processor 710 cause the processor to implement the various techniques described herein.

For example, medium 730 may include identify first unit and first allocation instructions 731. The identify first unit and first allocation instructions 731 may cause the processor to receive an indication of an incident via incident notification interface 740. The identify first unit and first allocation instructions 731 may further cause the processor to identify a first responding unit and allocate RF spectrum and transmission operational parameters. For example, the database 750 may include information about the location of the incident and available RF resources at the location.

The processor may then determine that shared spectrum resources are needed. Using the central authority interface 760, the processor may request shared spectrum resources. The first allocation of resources may then be sent to a first responder via the vehicle interface 770. As explained above, the first allocation may be sent via normal communications channels or the alternative backhaul. The identify first unit and first allocation instructions 731 are described throughout this description generally, including places such as the description of blocks 405-440.

The medium 730 may include second allocation instructions 732. The second allocation instructions 732 may cause the processor to determine that a second allocation of RF spectrum and transmission operation parameters are needed. The second allocation may be requested from the central authority via the central authority interface 760 and sent to the first responder via the vehicle interface 770. The second allocation instructions 732 are described throughout this description generally, including places such as the description of blocks 445 and 450.

The medium 730 may include backhaul instructions 733. The backhaul instructions 733 may cause the processor to determine and send to the first responder information that is used to cause the first responder to park in a location that reduces degradation of the backhaul capabilities. The backhaul instructions 733 are described throughout this description generally, including places such as the description of blocks 455-465.

The medium 730 may include second responding unit instructions 734. The second responding unit instructions 734 may cause the processor to determine there a second responding unit, along with a second allocation of RF spectrum and transmission operational parameters needs to be requested via the central authority interface 760 and sent to the second responder vehicle via the vehicle interface 770. The second responding unit instructions 734 are described throughout this description generally, including places such as the description of blocks 505-520.

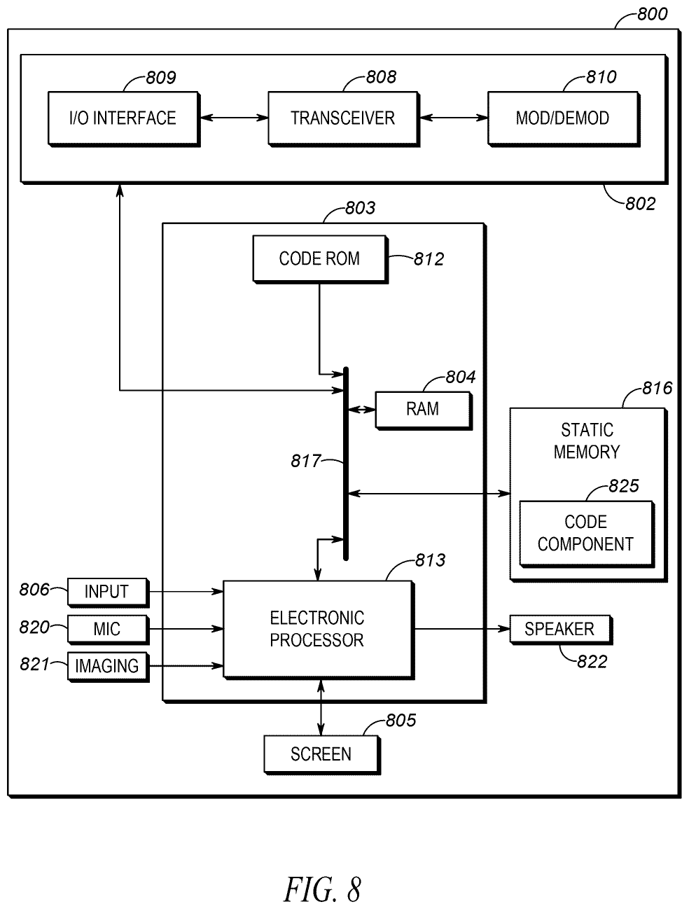

FIG. 8 is an example of a device 800 that may implement the mobile broadband device according to the techniques described herein. The communication device 800 may be, for example, embodied in the mobile LMR 112, the Mobile Broadband Radio 118, and the portable radio 172 and/or may be a distributed communication device across two or more of the foregoing (or multiple of a same type of one of the foregoing) and linked via a wired and/or wireless communication link(s). In some embodiments, the communication device 800 (for example, the portable radio 172) may be communicatively coupled to other devices such as the mobile broadband radio 118 as described above.

While FIG. 8 represents the communication devices described above with respect to FIG. 1, depending on the type of the communication device, the communication device 800 may include fewer or additional components in configurations different from that illustrated in FIG. 8. For example, in some embodiments, communication device 800 acting as the portable radio 172 may not include one or more of the screen 805, input device 806, and imaging device 821. As another example, in some embodiments, the communication device 800 acting as the portable radio 172 or the broadband mobile radio 118 may further include a location determination device (for example, a global positioning system (GPS) receiver). Other combinations are possible as well.

As shown in FIG. 8, communication device 800 includes a communications unit 802 coupled to a common data and address bus 817 of a processing unit 803. The communication device 800 may also include one or more input devices (e.g., keypad, pointing device, touch-sensitive surface, etc.) 806 and an electronic display screen 805 (which, in some embodiments, may be a touch screen and thus also act as an input device 806), each coupled to be in communication with the processing unit 803.

The microphone 820 may be present for capturing audio from a user and/or other environmental or background audio that is further processed by processing unit 803 in accordance with the remainder of this disclosure and/or is transmitted as voice or audio stream data, or as acoustical environment indications, by communications unit 802 to other portable radios and/or other communication devices. The imaging device 821 may provide video (still or moving images) of an area in a field of view of the communication device 800 for further processing by the processing unit 803 and/or for further transmission by the communications unit 802. A speaker 822 may be present for reproducing audio that is decoded from voice or audio streams of calls received via the communications unit 802 from other portable radios, from digital audio stored at the communication device 800, from other ad-hoc or direct mode devices, and/or from an infrastructure RAN device, or may playback alert tones or other types of pre-recorded audio.

The processing unit 803 may include a code Read Only Memory (ROM) 812 coupled to the common data and address bus 817 for storing data for initializing system components. The processing unit 803 may further include an electronic processor 813 (for example, a microprocessor or another electronic device) coupled, by the common data and address bus 817, to a Random Access Memory (RAM) 804 and a static memory 816.

The communications unit 802 may include one or more wired and/or wireless input/output (I/O) interfaces 809 that are configurable to communicate with other communication devices, such as the portable radio 172, the backhaul 114, mobile broadband radio 118, and mobile LMR 112.

For example, the communications unit 802 may include one or more wireless transceivers 808, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 802 may additionally or alternatively include one or more wireline transceivers 808, such as an Ethernet transceiver, a USB transceiver, or similar transceiver configurable to communicate via a twisted pair wire, a coaxial cable, a fiber-optic link, or a similar physical connection to a wireline network. The transceiver 808 is also coupled to a combined modulator/demodulator 810.

The electronic processor 813 has ports for coupling to the display screen 805, the input device 806, the microphone 820, the imaging device 821, and/or the speaker 822. Static memory 816 may store operating code 825 for the electronic processor 813 that, when executed, performs one or more of the steps set forth in FIG. 6 and accompanying text.

The static memory 816 may comprise, for example, a hard-disk drive (HDD), an optical disk drive such as a compact disk (CD) drive or digital versatile disk (DVD) drive, a solid state drive (SSD), a flash memory drive, or a tape drive, and the like.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot request spectrum allocation from a central authority and provide the granted allocation to a mobile broadband radio for use in communicating with a portable broadband radio, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a dispatch center, an indication of an incident requiring a response, the incident having an incident location;
identifying a first responding unit to respond to the incident;
determining broadband transmission capabilities of the first responding unit;
requesting a first allocation of Radio Frequency (RF) spectrum and transmission operational parameters covering at least a first portion of an area of the incident location based on the broadband transmission capabilities of the first responding unit; and
sending to the first responding unit an indication of the first allocation of RF spectrum, the transmission operational parameters, and the at least the first portion of the area of the incident location.

2. The method of claim 1, wherein requesting the first allocation further comprises:
contacting a spectrum server to obtain the first allocation of RF spectrum and transmission operational parameters.

3. The method of claim 1 further comprising:
providing, to the first responding unit, a recommended parking location within the at least the first portion of the area of the incident location.

4. The method of claim 1 further comprising:
requesting a second allocation of RF spectrum and transmission operational parameters covering at least a second portion of the area of the incident location based on the broadband capabilities of the first responding unit;
sending to the first responding unit an indication of the second allocation of RF spectrum, the transmission operational parameters, and the at least the second portion of the area of the incident location, wherein the first responding unit selects a parking location within the first portion of the area of the incident location or the second portion of the area of the incident location.

5. The method of claim 1 further comprising:
identifying a second responding unit to respond to the incident;
determining broadband capabilities of the second responding unit;
requesting a second allocation of RF spectrum and transmission operational parameters covering at least a second portion of the area of the incident location based on the broadband capabilities of the second responding unit; and
sending to the second responding unit an indication of the second allocation of RF spectrum, the transmission operational parameters, and the at least the second portion of the area of the incident location.

6. The method of claim 1 further comprising:
determining a backhaul capability of the first responding unit;
determining degradations within the at least the first portion of the area of the incident location that would interfere with the backhaul capability of the first responding unit; and
sending to the first responding unit an indication of areas within the at least the first portion of the area of the incident location where the backhaul capability of the first responding unit may be impacted by the degradations.

7. The method of claim 1 wherein requesting the first allocation of RF spectrum further comprises:
requesting RF spectrum from a Spectrum Access System (SAS) of a Citizens Broadband Radio Service (CBRS) operating in a 3.5 Gigahertz band that provides RF coverage at the location.

8. A system comprising:
a processor; and
a memory coupled to the processor, the memory containing thereon a set of instructions that when executed by the processor cause the processor to:
receive, at a dispatch center, an indication of an incident requiring a response, the incident having an incident location;
identify a first responding unit to respond to the incident;
determine broadband transmission capabilities of the first responding unit;
request a first allocation of Radio Frequency (RF) spectrum and transmission operational parameters covering at least a first portion of an area of the incident location based on the broadband transmission capabilities of the first responding unit; and
send to the first responding unit an indication of the first allocation of RF spectrum, the transmission operational parameters, and the at least the first portion of the area of the incident location.

9. The system of claim 8, wherein requesting the first allocation further comprises instructions that cause the processor to:
contact a spectrum server to obtain the first allocation of RF spectrum and transmission operational parameters.

10. The system of claim 8 further comprising instructions that cause the processor to:
provide, to the first responding unit, a recommended parking location within the at least the first portion of the area of the incident location.

11. The system of claim 8 further comprising instructions that cause the processor to:
request a second allocation of RF spectrum and transmission operational parameters covering at least a second portion of the area of the incident location based on the broadband capabilities of the first responding unit;
send to the first responding unit an indication of the second allocation of RF spectrum, the transmission operational parameters, and the at least the second portion of the area of the incident location, wherein the first responding unit selects a parking location within the first portion of the area of the incident location or the second portion of the area of the incident location.

12. The system of claim 8 further comprising instructions that cause the processor to:
identify a second responding unit to respond to the incident;
determine broadband capabilities of the second responding unit;
request a second allocation of RF spectrum and transmission operational parameters covering at least a second portion of the area of the incident location based on the broadband capabilities of the second responding unit; and
send to the second responding unit an indication of the second allocation of RF spectrum, the transmission operational parameters, and the at least the second portion of the area of the incident location.

13. The system of claim 8 further comprising instructions that cause the processor to:
determine a backhaul capability of the first responding unit;
determine degradations within the at least the first portion of the area of the incident location that would interfere with the backhaul capability of the first responding unit; and
send to the first responding unit an indication of areas within the at least the first portion of the area of the incident location where the backhaul capability of the first responding unit may be impacted by the degradations.

14. The system of claim 8 wherein requesting the first allocation of RF spectrum further comprises instructions that cause the processor to:
request RF spectrum from a Spectrum Access System (SAS) of a Citizens Broadband Radio Service (CBRS) operating in a 3.5 Gigahertz band that provides RF coverage at the location.

15. A non-transitory processor readable medium containing a set of instructions thereon that when executed by a processor cause the processor to:
receive, at a dispatch center, an indication of an incident requiring a response, the incident having an incident location;
identify a first responding unit to respond to the incident;
determine broadband transmission capabilities of the first responding unit;
request a first allocation of Radio Frequency (RF) spectrum and transmission operational parameters covering at least a first portion of an area of the incident location based on the broadband transmission capabilities of the first responding unit; and
send to the first responding unit an indication of the first allocation of RF spectrum, the transmission operational parameters, and the at least the first portion of the area of the incident location.

16. The medium of claim 15, wherein requesting the first allocation further comprises instructions that cause the processor to:
contact a spectrum server to obtain the first allocation of RF spectrum and transmission operational parameters.

17. The medium of claim 15 further comprising instructions that cause the processor to:
provide, to the first responding unit, a recommended parking location within the at least the first portion of the area of the incident location.

18. The medium of claim 15 further comprising instructions that cause the processor to:
request a second allocation of RF spectrum and transmission operational parameters covering at least a second portion of the area of the incident location based on the broadband capabilities of the first responding unit;
send to the first responding unit an indication of the second allocation of RF spectrum, the transmission operational parameters, and the at least the second portion of the area of the incident location, wherein the first responding unit selects a parking location within the first portion of the area of the incident location or the second portion of the area of the incident location.

19. The medium of claim 15 further comprising instructions that cause the processor to:
identify a second responding unit to respond to the incident;
determine broadband capabilities of the second responding unit;
request a second allocation of RF spectrum and transmission operational parameters covering at least a second portion of the area of the incident location based on the broadband capabilities of the second responding unit; and
send to the second responding unit an indication of the second allocation of RF spectrum, the transmission operational parameters, and the at least the second portion of the area of the incident location.

20. The medium of claim 15 further comprising instructions that cause the processor to:
determine a backhaul capability of the first responding unit;
determine degradations within the at least the first portion of the area of the incident location that would interfere with the backhaul capability of the first responding unit; and
send to the first responding unit an indication of areas within the at least the first portion of the area of the incident location where the backhaul capability of the first responding unit may be impacted by the degradations.
